(19) United States
(12) Patent Application Publication
(10) Pub. No.: US 2013/0055283 A1
(43) Pub. Date: Feb. 28, 2013

(54) Workload Performance Control

(71) Applicants: Satish Kumar Mopur, Bangalore (IN); Sumanesh Samanta, Bangalore (IN); Dinkar Sitaram, Bangalore (IN); Sijesh Thondapilly Balakrishnan, Bangalore (IN)

(72) Inventors: Satish Kumar Mopur, Bangalore (IN); Sumanesh Samanta, Bangalore (IN); Dinkar Sitaram, Bangalore (IN); Sijesh Thondapilly Balakrishnan, Bangalore (IN)

(73) Assignee: Dinkar Sitaram, Bangalore (IN)

(21) Appl. No.: 13/639,511

(22) PCT Filed: May 7, 2010
(86) PCT No.: PCT/US10/34009

§ 371 Date: Oct. 4, 2012

(51) Int. Cl. G06F 9/50

(52) U.S. Cl. 718/104; 718/102

(57) ABSTRACT

Methods to provide workload performance control are described herein. Performance statistics for a plurality of workloads are obtained for a second time interval, which includes a plurality of first time intervals. The performance statistics is based on monitored data (220) obtained at each of the plurality of first time intervals. From the plurality of workloads, at least one workload having an anomaly in resource allocation is identified using the performance statistics. Resources, to at least mitigate the anomaly are associated with the at least one workload.

### TECHNICAL FIELD

The present subject matter relates, in general, to network environments and, in particular, workload performance control in the network environments.

### BACKGROUND

Generally, computing devices in a network environment, issue multiple application commands that compete with each other for gaining access to resources available with one or more of the computing devices, also referred to as target devices. Resources, such as processing capabilities, storage capabilities and network throughput, are generally shared across a network of computing devices because of the limited availability of these resources. Resources can be managed and accessed, based on a desired priority, which can be indicated through Quality-of-Service (QoS), requested by any device connected to the network. For example, a critical application command may have a higher priority associated with it as compared to a non-critical application command. Accordingly, a higher proportion of resources may be allocated to the critical application than the non-critical application.

In order to provide the expected QoS, application commands can be classified and accordingly prioritized at the target device. Generally, schedulers and QoS controllers are implemented to provide the expected QoS. A QoS controller determines resources to be allocated to the application commands based on performances of the application commands. Further, the QoS controller provides information regarding dynamic adjustment of resource allocation on a periodic basis to a scheduler, so that the expected QoS is achieved for the application commands. Accordingly, the scheduler places the application commands in multiple queues at various ports of the target device.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary network environment implementing workload performance control, in accordance with an embodiment of the present invention.

FIG. 2a illustrates exemplary components of a computing device implementing workload performance control, in accordance with an embodiment of the present invention.

FIG. 2b illustrates an exemplary state transition diagram for a QoS control module implementing workload performance control, in accordance with an embodiment of the present invention.

FIG. 3 illustrates an exemplary method for providing workload performance control, in accordance with an embodiment of the present invention.

### SUMMARY

This summary is provided to introduce concepts related to workload performance control, which are further described below in the detailed description. This summary is not intended to identify essential features of the claimed subject matter nor is it intended tor use in determining or limiting the scope of the claimed subject matter.

According to an embodiment of the present invention, a method to provide workload performance control is described herein. In one implementation, performance statistics (or a plurality of workloads ere obtained for a second time interval including a plurality of first time intervals. The performance statistics is based on monitored data obtained at each of the plurality of first time intervals. From the plurality of workloads, at least one workload having an anomaly in resource allocation is identified using the performance statistics. Subsequent to identification resources, to at least mitigate the anomaly, are associated with the at least one workload.

According to another embodiment of the present invention, a computing device to provide workload performance control is described herein. In one implementation, the computing device includes a Quality of Service (QoS) control module. The QoS control module is configured to control performance of each of the plurality of workloads based at least on the monitored data obtained at the first time interval. The QoS control module is further configured to control the performance of the plurality of workloads based at least on the monitored data obtained over the second time interval.

According to yet another embodiment of the present invention, a computer-readable medium having computer-executable instructions to perform workload performance control is described herein. In one implementation, the computer-readable medium includes instructions for obtaining the monitored data at each of the plurality of first time intervals, for the plurality of workloads. Based on the monitored data obtained at each of the plurality of the first intervals, performance statistics of each of the plurality of the workloads for a second time interval is computed. The second time interval includes the plurality of first time intervals. An anomaly in resource allocation associated with at least one workload, from the plurality of workloads, is ascertained based on the performance statistics. Subsequent to ascertaining of the anomaly, the resources, to at least reduce the anomaly, are associated with the at least one workload.

### DETAILED DESCRIPTION

Devices and methods for workload performance control are described herein. These devices and methods can be implemented in a variety of operating systems, such as Hewlett Packard Unix (HP-UX), and also in a virtual machine (VM) environment using a variety of system architectures, for example, Hyper-V architectures, Multi-Core architectures, and the like. Devices that can implement the described methods include a diversity of computing devices, such as a server, a desktop personal computer a notebook or a portable computer, a workstation, a mainframe computer, a mobile computing device, and an entertainment device.

In a network environment, multiple host devices send application commands, or workloads, to one or more target devices. The workloads can be generated by one or more applications executing at the host devices. The workloads can include a storage resource request, a request for a network resource, or a processing resource request. Once the workloads are received at a target device, one or more schedulers place the application commands in one or more queues at various ports of the target device.

Further, each workload can be associated with one or more Quality of Service (QoS) parameters. The QoS parameters are indicative of the resources that are to be allocated to the associated workload to achieve the required QoS. It would also be appreciated that different workloads can have different QoS expectations, and consequently different QoS parameters. For example, a voice over internet protocol (VoIP) application command expects higher bandwidth as compared to an e-mail application command. Therefore, a QoS parameter associated with the former application command can be indicative of a greater bandwidth allocation, as compared to a QoS parameter associated with the latter application command. Examples of the QoS parameters include, but are not limited to, throughput, bandwidth, latency, jitter, loss ratio, error rate, etc. Further, examples of target devices include, but are not limited to, routers, storage devices, and processors.

Generally, a QoS controller is implemented to control performances of workloads, and can be implemented as a discrete controller. Performance of a workload may be determined based on the achieved QoS by the workload. The QoS controller determines in each control interval whether the performances of individual workloads are met with reference to an expected QoS. Each control interval may be of a predetermined time period. In each control interval, the QoS controller computes resources, for example, processing resources, storage resources, to be allocated to the workloads, based on the performance of the workloads in the preceding control interval. The computed resources that are to be allocated can be communicated to the schedulers. Accordingly, the schedulers allocate the computed resources to the workloads such that the expected QoS of the application commands is met in the subsequent control intervals.

The QoS controller, typically, enables immediate QoS control at short control intervals, to meet the expected QoS for the workloads. However, in some cases the control interval may be too shop to detect anomalies in resource allocations, such as oscillations in resource allocation, resource allocation that results in resource hogging by a workload, resource allocation to attain an unachievable expected QoS associated with a workload, etc. The presence of one or more of such anomalies may lead to imbalances in resource allocation for one or more workloads. These anomalies, if not corrected, may adversely affect the performance of the workloads that are contending for the resource. Furthermore, resource allocation based solely on long-term observations would result in slow and poor QoS control, thereby, degrading performance of the workloads.

To this end, devices and methods to provide effective workload performance control to achieve an expected QoS are described, in one embodiment, the resource allocation requirements for the workloads can be dynamically computed, along with detecting and controlling one or more anomalies. In an implementation, information pertaining to performances of the workloads is gathered for a first time interval, which can be equivalent to a control interval. The performances of the workloads with respect to the expected QoS can be indicated through performance statistics. The performance statistics include, amongst other information, information pertaining to QoS achieved by the workloads. Further, the performance statistics may also include information pertaining to QoS parameters associated with the workloads, which are indicative of QoS expected by the workloads. A QoS control within each control interval is provided based on the performance statistics of each of the workloads. Once the performance statistics are obtained, workload performance control is provided for the subsequent control intervals, based on the performance statistics gathered in the preceding control interval.

However, it may be the case that an anomaly occurs despite providing the QoS control at regular control intervals. In an implementation, the performance statistics of the workloads for a second time interval are monitored. The second time interval may include a plurality of the first time intervals. Thus, for the second time interval the performance statistics are observed for a longer time interval, in addition to being observed at a short time interval. The performance statistics are based on the performance of the workloads, which is monitored at each of the plurality of the first interval in the second time interval. The first time interval and the second time interval may be predetermined and may be adjusted or set by a user.

Based on the performance statistics gathered over the second time interval, it can be ascertained whether an anomaly has occurred in resource allocation or not. In case no anomaly is detected, the current resource allocation for the workloads is continued. In case, an anomaly is detected, optimal resources to be allocated to the workloads are computed to enhance the performance of the workloads. In this way, a workload performance control is provided, which is able to address and reduce the anomalies mentioned above.

It will be appreciated by the one skilled in the art that the words “optimize”, “optimal”, and related terms that refer to improvement in performance of workload, do not purport that the workload has achieved, or is capable of achieving, the “best” or perfect performance or perfectly efficient state.

In one implementation, the method may be used for workload performance control in a storage area network (SAN) environment. In another implementation, the method may be used to deliver QoS to workloads competing for shared resources, such as access or allocation of bandwidth, in a network environment. The method can also be used to monitor and optimize workload performance according to different user requirements.

In one embodiment the workload performance control may be provided by implementing a QoS control module that includes a first controller and a second controller. The first controller may be configured to perform resource allocation to workloads based on the performance statistics of the workloads gathered ever the first time interval. The second controller may be configured to detect the anomalies in the resource allocation based on the performance statistics of the workloads gathered over the second time interval. In case an anomaly is detected, the second controller computes optimal resources to be allocated to the workloads and the scheduler may provide the optimal resources to the workloads.

While aspects of described systems and methods for workload performance control can be implemented in any number of different computing devices, environments, and/or configurations, the implementations are described in the context of the following exemplary device architecture(s).

### Exemplary System

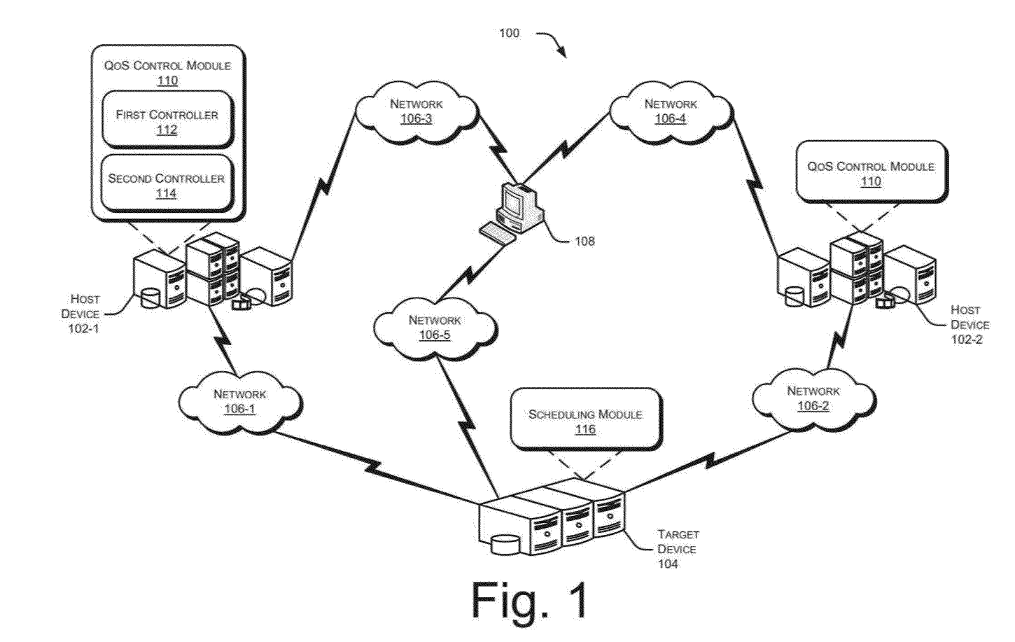

The manner in which workload performance control is implemented shall be explained in detail with respect to the FIGS. 1-3. While aspects of device and methods can be implemented in any number of different computing systems, environments, and/or configurations, the embodiments are described in the context of the following exemplary system architecture(s).

FIG. 1 illustrates a network environment 100 implementing workload performance control, in accordance with an embodiment of the present invention. The concepts described herein can be applied for workload performance control in any network environment having a variety of network devices, such as routers, bridges, computing devices, storage devices, servers, etc. For example, the network environment 100 may be a storage area network (SAN). The network environment 100 may be based on different standards for physically connecting and transferring data between the devices provided in the network environment 100. Examples or such standards include, but are not limited to, small computer system interface (SCSI), internet SCSI (iSCSI), fibre channel, and fibre channel over Ethernet (FCoE). The network environment 100 includes a plurality of host devices, such as host devices 102-1 and 102-2, communicating with at least one target device 104. The host devices 102-1 and 102-2, hereinafter collectively referred to as the host devices 102, and the target device 104 communicate via networks 106-1 106-2 106-3, 106-4, and 106-5, hereinafter collectively referred to as networks 106.

The networks 106 may be wireless or wired networks, or a combination thereof. The networks 106 can be a collection of individual networks, interconnected with each other and functioning as a single large network, for example the internet or an intranet. Examples of such individual networks include, but are not limited to, Storage Area Networks (SANs), Local Area Networks (LANs), Wide Area Networks (WANs) and Metropolitan Area Networks (MANs). The networks 106 may also include network devices such as hubs, switches, routers, and so on. In an implementation, the target device 104 has data storage capability and provides service, such as data storage, to the host devices 102. Examples of the target device 104 include, but are not limited to, workstations, network servers, storage servers, block storage devices, other hosts and so on. In another implementation, the target device 104 may be a network device, such as a router or a bridge that can manage network traffic, for example, by allocating bandwidth to the host devices 102.

The network 100 further includes an interface console 108 (hereinafter referred to as the console 108). The console 108 can be implemented as any one or combination of a personal computer, a workstation or a laptop, etc. In an implementation, the console 108 facilitates centralized management of the network QoS. The console 108 may provide a user interface to facilitate defining QoS requirement levels or QoS parameters including input/output (I/O) usage parameters, bandwidth parameters, sequential access indicators, etc. for achieving/defining an expected QoS. For example, a user or network administrator can specify a latency goal of 5 milliseconds for a workload generated by an application hosted on a host device, say 102-1, and serviced by the target device 104. Further, the user may specify a minimum bandwidth or throughput goal of 100 megabytes per second (MBps) to be accomplished for another workload hosted on the same host device 102-1 or a different host device 102-2, serviced by the same target device 104.

In an implementation, the console 108 may also communicate with the host devices 102. The host devices 102 may also interact with each other. Each of the host devices 102 may be a networked computing device, for example, a personal computer, a workstation, a server, etc, that hosts various applications. The host devices 102 can also be configured to provide service to, and request service from, other devices connected to the networks 106, for example, the target device 104. Further, each of the host devices 102 can include a QoS control module 110 to provide workload performance control at the target device 104. The QoS control module 110 comprises a first controller 112 and a second controller 114.

Further, the QoS control module 110 may communicate with the console 108 through the networks 106 to facilitate QoS management. Accordingly, the console 108 communicates information, such as information related to the workloads, the expected QoS and any other pertinent information, to the QoS control module 110 for controlling the performances of the workloads.

One or more applications executing in the host devices 102 may generate a set of application commands, or workloads, to perform one or more operations, such as a data read from, or write to, the target device 104. The workloads cars be scheduled to provide an expected QoS at the target device 104 based on one or more QoS parameters or service level agreements (SLAs) associated with the workloads. The SLAs delineate the performance expected for a workload in the network, such as a minimum throughput of 50 MB/s or a maximum latency of 25 ms, and the like. These SLAs can be used for classifying the workloads. The workloads can then be processed at the target device 104 based on such a classification to deliver the requested service at the expected QoS.

Once the workloads are received at the target device 104, a scheduling module 116 in the target device 104 queues the received workloads at one or more ports of the target device 104. Typically, the scheduling module 116 allows at least one workload to be processed from each queue after a fixed period of time has elapsed. In one implementation, the QoS control module 110 provides information to the scheduling module 116 regarding allocation of resources for each workload to achieve the expected QoS. Hence, based on the expected QoS of the workloads, the QoS control module 110 controls the scheduling module 116, which subsequently schedules the workloads at the target device 104. The workloads are allocated the necessary resources to achieve the expected QoS. In one implementation, the resource allocation is based on a performance measurement of the workloads, also referred to as performance statistics. The performance measurements can be made at regular control intervals and provided to the first controller 112.

The resource allocation based on performance measurements provided to the first controller 112 may result in certain anomalies, which are explained with specific examples below. Consider that a host device, say the host device 102-1, generates a workload, hereinafter a first workload, with the expected QoS of maximum latency of 25 milliseconds. The host device 102-1 may further generate another workload, hereinafter a second workload, which also has the expected QoS as the maximum latency of 25 milliseconds (ms). Based on the performance statistics, if the second controller 114 determines that the least possible latency for the first application is 200 ms even on allocating all the available resources, the second controller 114 may indicate that the maximum latency of 25 ms is an unachievable performance requirement, i.e. unachievable expected QoS, for the first workload. Since the minimum latency of 25 ms was unachievable for the first workload and still resources were being allocated to the first workload, the latency of the second workload may increase because the second workload is unable to access the required resources.

Infinite oscillation in resource allocation may arise in situations where the workload generation by the host devices is varying periodically. In such a situation, resource allocation by the scheduling module 116 also oscillates, say between a maximum value and a minimum value. Such oscillation in resource allocation is not desirable.

It may also happen that the resource requirements of a workload drop, for example, when there is less generation of similar workloads, in such a case, the first controller 112 may not be able to distinguish this from a temporary drop in resource requirement of the workload. Therefore, the first controller 112 would still direct the scheduling module 116 to allocate resources to the workload, based on, for example, the expected QoS of the workload. The workload may not be able to utilize the allocated resources in this situation. Such a situation may be referred to as a resource hogging situation by a workload.

In order to reduce or mitigate the anomalies, the second controller 114 is implemented in the QoS control module 110. It would be appreciated by one skilled in the art that terms “mitigate”, “reduce”, and related terms that refer to reduction in occurrence of such anomalies, do not purport that the mitigation of the anomalies would lead to elimination of these anomalies. In an implementation, the second controller 114 uses performance measurements over a larger period, i.e., uses a control interval larger than the short control interval of the first controller 112. The second controller 114 then ascertains whether an anomaly is present in the resource allocation to a workload based on the performance measurements. In case the second controller 114 detects an anomaly, it computes optimal proportion of resources, or optimal resources, for the workload and directs the scheduling module 116 to allocate the optimal resources to the workload. The second controller 114, using the performance measurements for the larger control intervals, continuously monitors the performance of the workload, in this manner, the second controller 114 is able to address the anomalies mentioned above.

In operation, when the workload performance control is started, i.e., the second controller 114 is initiated, the first controller 112 is disabled. Moreover, the second controller 114 does not control the operation of the scheduling module 116. The second controller 114 uses the performance statistics of all the workloads to obtain information indicating which all workloads have over-achieved, under achieved, and optimally achieved corresponding expected QoS, in the absence of any control by the QoS control module 110, which control is also referred to as dynamic resource control. Based on the performance statistics, reference performance values for each workload are computed over an extended duration. This is referred to as the monitoring state.

The first controller 112 is then allowed to run and perform resource allocations for the workloads based on the performance statistics in the short control interval. In each short control interval, also referred to as an iteration of the first controller 112, the first controller 112 uses the performance statistics gathered over the short control interval to perform the resource allocation in the next short control interval. The short control interval for the first controller 112 can be of a first time interval which may be a user-defined parameter. After a predetermined number of iterations, say n iterations of the first controller 112, another performance statistics of the workloads is obtained, which includes the performance statistics for each of the n iterations. The time taken for n iterations may be referred to as the second time interval.

If the performance statistics of the workloads suggest that a predetermined proportion of the workloads have not achieved their expected QoS, both the first controller 112 and the second controller 114 are disabled for another predetermined period. After this predetermined period has elapsed, the first controller 112 is enabled and the workload performance control is activated. Further, the second controller 114 determines an optimal resource allocation for those workloads corresponding to the predetermined proportion.

In one implementation, to determine the optimal source allocation, the second controller 114 computes a peak performance and determines a minimum resource allocation for which the peak performance was achieved, based on the performance statistics gathered over the second time interval. For example, within the ‘n’ iterations, the peak performance, say minimum latency of 20 milliseconds, may have been achieved for resource allocations of say 10%, 20%, 30% (of a total 100% resource availability for control). The minimum resource allocation for which the peak performance was achieved would be 10%.

The second controller 114 uses the performance statistics, which are gathered over the second time interval, to ascertain whether any anomaly is present in the resource allocation for the workloads determined/actually allocated by the first controller 112. If the second controller 114 detects no anomaly in the resource allocation computed/actually allocated by the first controller 112, the first controller 112 is allowed to perform resource allocation for all the workloads without any interference by the second controller 114.

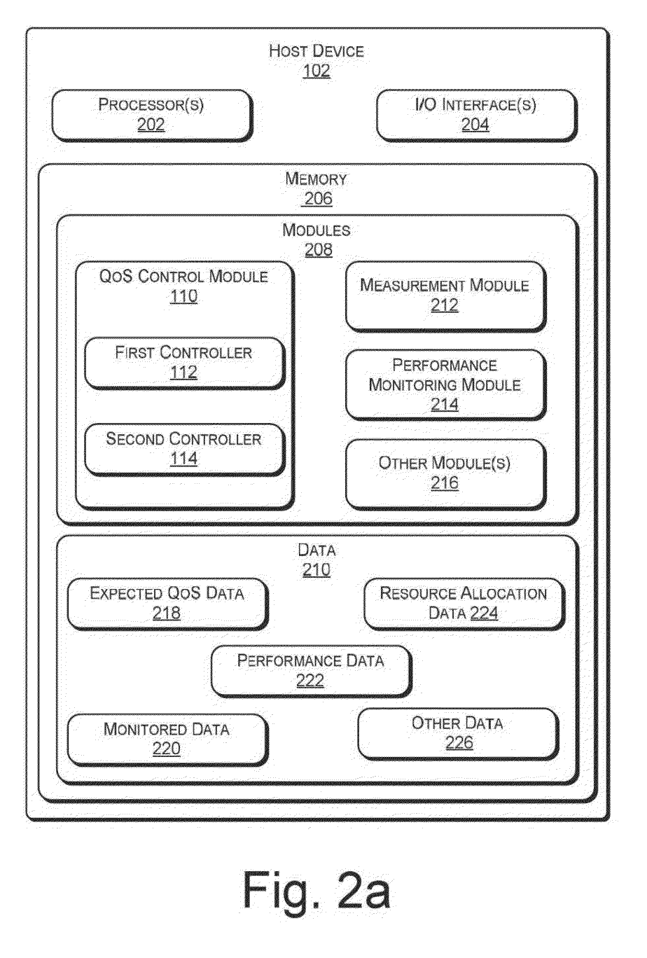

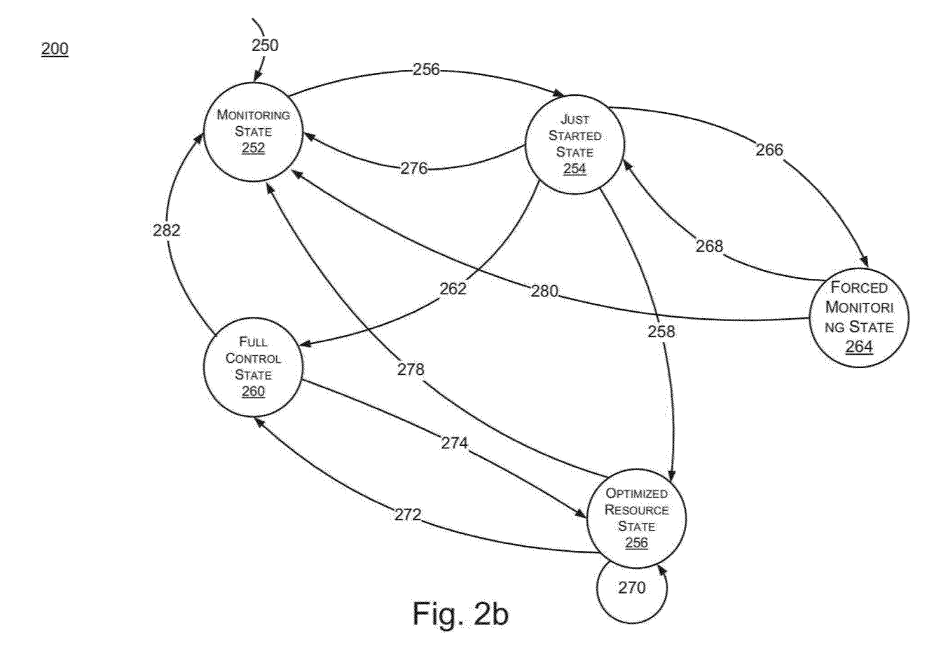

The manner in which workload performance control is achieved is implemented is further explained in detail in conjunction with FIGS. 2a and 2b. FIG. 2a illustrates exemplary components of the host device 102, and FIG. 2b illustrates an exemplary state transition diagram 200 for the QoS control module 110, according to an embodiment of the present invention. The host device 102 may include one or more processors) 202, one or more I/O interfaces 204 and a memory 206. The processor 202 may include microprocessors, microcomputers, microcontrollers, digital signal processors, central processing units, state machines, logic circuitries and/or any devices that manipulate signals and data based on operational instructions. Among other capabilities, the processor 202 is configured to fetch and execute computer-readable instructions stored in the memory 206.

The I/O interface(s) 204 may include a variety of software and hardware interfaces, for example, interface for peripheral device(s) such as data input/output devices, storage devices, network devices, etc. The I/O interface 204 may include Universal Serial Bus (USB) ports, Ethernet ports, Host Bus Adaptors, etc and their corresponding device drivers. The I/O interface 204, amongst other things, facilitates receipt of information by the host device 102 from other devices in the networks 106, such as the target device 104 and the console 108.

The memory 206 can include any computer-readable medium including, for example, volatile memory such as static random access memory (RAM) and dynamic RAMs, and/or non-volatile memory, such as read only memory (ROM), erasable programmable ROM, flash memories, hard disks, optical disks, and magnetic tapes. The memory 206 further includes modules 208 and data 210. The modules 208 include the QoS control module 110, a measurement module 212, a performance monitoring module 214, and other module(s) 216, The data 210 serve as repositories for storing information associated with the modules 208 and any other information. In an implementation, the data 210 includes expected QoS data 218, monitored data 220, performance data 222, resource allocation data 224, and other data 226. The other modules 216 may include one or more applications on the host device 102 that generate one or more workloads. The other data 226 includes data used by, or generated as a result of, the execution of one or more modules in the modules 208.

In an implementation, the measurement module 212 continuously determines the performances of the workloads accessing the target device 104 for performing one or more functions, such as read or write operations on data stored in the target device 104. The information pertaining to the performances of the workloads, which include QoS achieved by the workloads, may be stored in the monitored data 220. Further, data pertaining to expected QoS requirements, i.e., SLAs associated with each of the workloads may be stored in the expected QoS data 218. In one implementation, the expected QoS data 218 may be provided to the QoS control module 110 by the console 108. For the purposes of explanation, performance statistics include the information pertaining to the performances of the workloads with respect to the expected QoS.

As previously mentioned, the QoS control module 110 includes the first controller 112 and the second controller 114. The first controller 112 provides QoS control based on the expected QoS data 218 and the monitored data 220 gathered continuously at discrete time intervals, i.e., a control interval of the first controller 112. The control interval for the first controller 112 may be of the first time interval, say 2 seconds. The first controller 112 determines the resources to be allocated to each of the workloads. The information pertaining to the resource allocation may be stored in the resource allocation data 224. The scheduling module 116 at the target device 104 can use the resource allocation data 224 for scheduling the workloads. The first controller 112 further provides workload performance control within each control interval, based on the expected QoS data 218 and the monitored data 220 both gathered at the first time interval.

In one implementation, the performance monitoring module 214 monitors the performance of the workloads for a second time interval. The second time interval includes a plurality of first time intervals. In other words, if the second time interval comprises ‘n’ first time intervals, then the performance monitoring module 214 uses the monitored data 220 gathered at each of the ‘n’ first time intervals. For example, the performance monitoring module 214 monitors the performances of the workloads for, say, 30 iterations of the first controller 112, where each iteration takes 3 seconds. Hence, in the above example, the performance monitoring module 214 analyzes the information pertaining to the performances of the workloads gathered over 90 seconds (30 iterations of 3 seconds each).

The performance monitoring module 214 then evaluates the performance statistics of the workloads corresponding to the second time interval, based on the monitored data 220 and the expected QoS data 218, both gathered in the second time interval, in one implementation, the performance statistics of the workloads may be stored in performance data 222. The performance statistics may include information indicating the proportion of the workloads that had over-achieved, under-achieved, or optimally achieved their respective QoS. The performance statistics may further include information pertaining to the performances of the workloads gathered at each of the plurality of first time intervals. Once the performance statistics are gathered, the second controller 114 provides checks for anomalies present in the resource allocation based on the performance data 222. Accordingly, the second controller 114 can reduce anomalies, which were hampering the performance of the workloads. Although the performance monitoring module 214 and the second controller 114 have been illustrated as two separate modules, it will be appreciated that the functionalities of the two modules 214 and 114 may be combined together in a single module.

During operation, upon detecting any anomaly the second controller 114 may guide or control the first controller 112. In case an anomaly is defected in the resource allocation of a workload, the second controller 114 determines an optimum amount of resources to be allocated to the workload, i.e. optimal resources for the workload. Subsequent to the determination of the optimal resources, the second controller 114 may direct the first controller 112 to control the allocation of the optimal resources to the workloads, thereby facilitating effective workload performance control. The information pertaining to the optimal resources may be stored in the resource allocation data 224.

In one implementation, the resource allocation data 224 is communicated to the scheduling module 116. Accordingly, the scheduling module 116 performs the scheduling of the workloads at the target device 104 based on the resource allocation data 224. Further, in case no anomaly is detected, the first controller 112 is allowed to dynamically allocate the resources independently to the workloads. Thus, in case of an anomaly, the scheduling module 116 may perform the scheduling of the workloads based on the optimal resources determined by the second controller 114, while in case no anomaly is defected, the scheduling module 116 performs scheduling of the workloads based on the resource allocation performed by the first controller 112.

The working of the QoS control module 110 can be further understood in conjunction with FIG. 2b. FIG. 2b indicates the state transition diagram 200, indicating the various states of the QoS control module 110, in accordance with an embodiment of the present invention. The state transition diagram 200 is described to elucidate operation of the QoS control module 110. The order in which the state transition diagram 200 is described is not intended to be construed as a limitation, and any number of the described states can be combined in any order to provide the QoS control. Additionally, individual states may be deleted from the state transition diagram 200 without departing from the spirit and scope of the invention described herein.

In operation, upon initiation of the QoS control module 110, indicated by arrow 250 in FIG. 2b, the QoS control module 110 enters a monitoring state 252. In the monitoring state 252, the first controller 112 is disabled and no dynamic resource allocation control happens. Accordingly, in the monitoring state 252, the workloads are scheduled based on a predefined logic of the scheduling module 116. The QoS control module 110 may remain in the monitoring state 252 for a predefined time interval. Further, the predefined interval may be a user-defined parameter.

In the monitoring state 252, the measurement module 212 gathers the monitored data 220 for the predefined interval. The second controller 114 uses this monitored data 220 to determine reference performance values of the workloads in the absence of any dynamic resource allocation control. In one implementation, the reference performance values may be determined using a moving average technique; however, other techniques may also be used. The reference performance values may be stored in the performance data 222.

Continuing in the monitoring state 252, the second controller 114 may compare, for each of the workloads, the reference performance values with expected QoS parameters associated with the workload. Based on the comparison, the second controller 114 may determine the amount of resources to he allocated to the workloads so that the expected QoS is achieved. The second controller 114 may use this information to compute resources to be allocated in subsequent states. After the predefined interval lapses, the QoS control module 110 transits to a just started state 254 (path 256).

In the just started state 254, the first controller 112 is activated and allowed to perform resource allocation, in one implementation, after the plurality of first time intervals, i.e. after n iterations of the first controller 112, the performance monitoring module 214 obtains the performance statistics for each of the workloads for the second time interval and stores the associated performance statistics in the performance data 222. The performance statistics may further include cumulative information pertaining to the performances of the workloads gathered at each of the plurality of first time intervals. Based on the performance data 222, the second controller 114 determines if any anomaly in the resource allocation has occurred. As previously mentioned, the anomalies include unachievable expected QoS associated with the workloads, oscillations in resource allocation, resource hogging by the workloads, etc. Upon detection of an anomaly, the second controller 114 may determine optimal resource allocation for the workloads having the anomaly. The anomalies may be detected and optimal resource allocation may be achieved in one or more of the following exemplary manners.

In one implementation, the second controller 114 determines, for each workload, a peak performance and a minimum resource allocation for which the peak performance is achieved, using the performance data 222 and stores them in the performance data 222. For example, within the n iterations, the peak performance of a workload, say minimum latency of 20 milliseconds, may have been achieved with the resource allocation of 10%, 15%, and 18% resources of the total resource available for allocation. In this example, the minimum resource allocation for which the peak performance is achieved would be 10%. In the same example, if it is determined that a current resource allocation for a workload, i.e., resource allocated to the workload subsequent to the lapse of the predetermined number of iterations of the first controller 112, is greater than the minimum resource allocation for the workload, then workload is said to have an unachievable QoS requirement or inefficient QoS requirement associated with it. In such a case, the optimal resource allocation for the workload would be the minimum resource allocation. With reference to the example, it may be understood that the same performance of the workload may be achieved with lesser amount of resources, and accordingly, a resource allocation of 10% may be determined as the optimal resource so that other workloads do not starve for the resources.

In another example, during the just started state 254, the second controller 114 may detect oscillations in resource allocation by implementing a regression analysis technique. However, other techniques for detecting oscillations in resource allocation may also be used. For example, a simple linear regression analysis may be used to defect the oscillations. In the simple linear regression, error residual oscillations may be used to determine an error component in the resource allocation. The oscillations in the resource allocation can be inferred based on toggling of the error residual with large values. Subsequent to detection, the optimized resource may be computed using techniques such as a moving average technique. The optimized resource may also be fixed at a certain fraction of an oscillation amplitude. For instance, if the resource allocation oscillates between say 10% and 20%, the optimized resource can be fixed at, say, 15%.

In yet another example, to detect resource hogging, a correlation technique may be used to check whether an increase in resource allocation leads to a significant improvement in the performances of a workload. In other words, resource hogging is said to occur when a workload does not require a high amount of resources but is still provided with the high amount of the resources. This may in turn adversely affect the performances of the other workloads. The optimal resource, in case of the resource hogging situation, may be the maximum resource allocation at which a further increment in resource allocation does not result in significant improvement in the performances of the corresponding workload.

In case any one or more of the above mentioned anomalies are detected, the QoS control module 110 moves to an optimized resource state 256 (path 258). On the other hand, in case the second controller 114 determines that all the workloads achieved the corresponding expected QoS, i.e., no anomaly is detected, the QoS control module 110 transits to a foil control state 260 (path 262). Furthermore, if a threshold proportion of the workloads did not achieve the expected QoS, the QoS control module 110 transits to a forced monitoring state 264 (path 266).

In the forced monitoring state 264, the QoS control module 110 does not perform resource allocation to meet the expected QoS requirements of the workloads. Instead, the workloads are scheduled based on a predefined logic of the scheduling module 116, as in the monitoring state 252. In one implementation, the QoS control module 110 remains in the forced monitoring state 264 for a given period of time. Subsequent to lapse of this given period of time, the QoS control module 110 transits back to the Just started state 254 (path 268). In another implementation, a user may manually restart the QoS control module 110. Further, in such a situation, the user may adjust QoS requirements of the workloads.

As mentioned previously, if one or more anomalies are detected, the QoS control module 110 moves to the optimized resource state 256. In one implementation, the second controller 114 directs the scheduling module 116 to allocate the optimal resources to the respective workloads. Further, upon entering the optimized resource state 256, the QoS control module 110 determines individual performances (hereinafter referred to as individual reference performance) of the workloads that had anomalies in resource allocations. In one implementation, in the optimized resource state 256, based on the performance data 222, the performances of such workloads may be monitored periodically. Further, the second controller 114 may periodically monitor the performances of such workloads unless a state transition from the optimized resource state 256 occurs. In one implementation, the second controller 114 may monitor the performances of such workloads for a predetermined number of iterations, say ‘p’ iterations, of the first controller 112 to determine if the resource allocation for such workloads has been optimized. The predetermined iterations may be set or adjusted based on the preferences of a user.

Subsequent to ‘p’ iterations, the second controller 114 determines if the performances of such workloads has degraded over the ‘p’ iterations, i.e., if the resource allocation for none of such workloads is optimized. The second controller 114 may determine this by comparing current performance of such workloads with the individual reference performances. If resource allocation for none of such workloads is optimized, the QoS control module 110 transits to the full control state 260 (path 272).

Further, if it is determined that resource allocation for at least, one of such workloads is optimized, the QoS control module 110 remains in the optimized resource state 256 as indicated by the path 270. In this case, the second controller 114 attempts to allocate optimal resources to those of such workloads whose performance did not worsen during the ‘p’ iterations. Additionally, the second controller 114 allows the first controller 112 to allocate resources to those of such workloads whose performances degraded.

In the full control state 260, the first controller 112 is run without any restriction, i.e., the first controller 112 is allowed to perform resource allocation for all the workloads. In such a case, the second controller 114 periodically monitors the performances of the workloads to defect anomalies in the resource allocation, as in the just started state 254. In case an anomaly is defected, the QoS control module 110 transits back to the optimized resource state 256 (path 274). Further, the QoS control module 110 remains in the full control state 260 until a state transition occurs.

Further, if at any time, when the QoS control module 110 is in one of the just started state 254, the optimized resource state 256, the full control state 260 or the forced monitoring state 264, and an external event is triggered, for example, a workload is added to, or removed from, a queue, the QoS control module 110 returns to the monitoring state 252, as indicated by arrows 276, 278, 280, and 282, respectively.

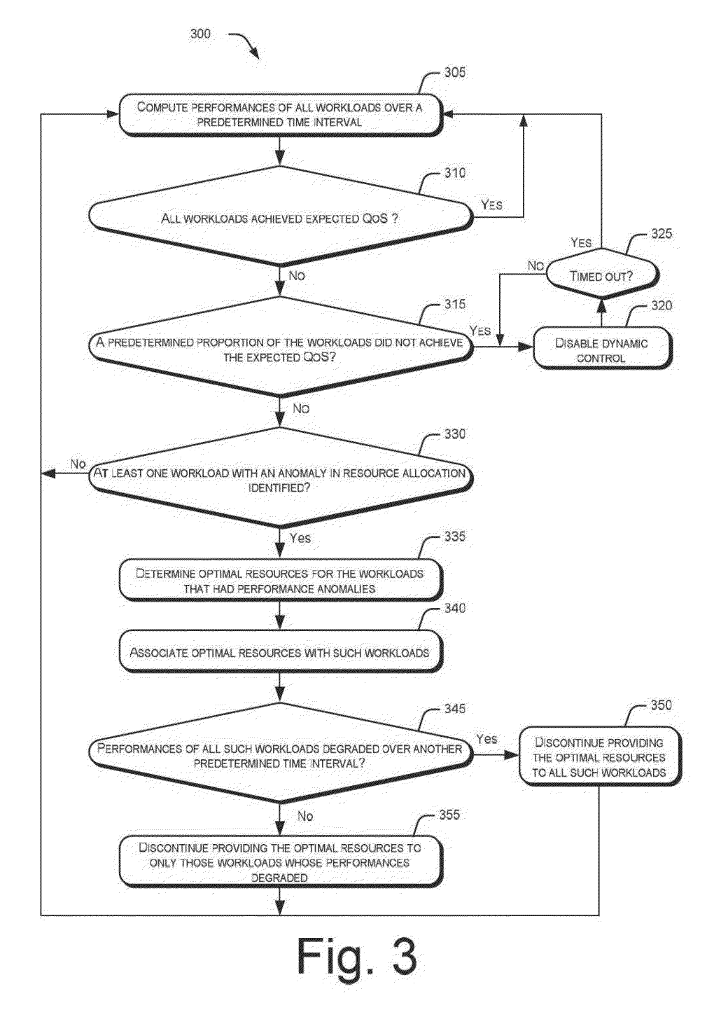

FIG. 3 illustrates an exemplary method 300 for workload performance control according to an embodiment of the present invention. These exemplary methods may be described in the general context of computer executable instructions. Generally, computer executable instructions can include routines, programs, objects, components, data structures, procedures, modules, functions, and the like that perform particular functions or implement particular abstract data types. The computer executable instructions can be stored on a computer readable medium and can be loaded or embedded in an appropriate device for execution.

The order in which the method is described is not intended to be construed as a limitation, and any number of the described method blocks can be combined in any order to implement the method, or an alternate method. Additionally, individual blocks may be deleted from the method without departing from the spirit and scope of the invention described herein. Furthermore, the method can be implemented in any suitable hardware, software, firmware, or combination thereof.

The method 300 has been described in detail with respect to a QoS control module, for example, the QoS control module 110, traversing through various states described above, such as, the just started state 254 and the optimized resource state 270. Further, the method 300 does not take into consideration occurrence of an external event, such as addition or removal of a workload from a queue. In case, an external event takes place, the method 300 is halted and the QoS control module transits to a monitoring state, such as the monitoring state 252.

At block 305, performance statistics of all workloads are computed, based on performances of the workloads, over a predetermined time interval. In an implementation, the predetermined time interval can be the second time interval as mentioned above. A peak performance value, and a minimum resource allocation for which the peak performance value was achieved may be determined using the monitored data 220. The second controller 114 may determine the peak performance values, which may be stored in the performance data 222. The peak performance values may be included in the performance statistics stored in the performance data 222. During the predetermined time interval the scheduling module 116 schedules the workloads based on resource allocation performed by the first controller 112. The scheduling of the workloads may be based on the resource allocation data 224.

In an implementation, prior to block 305, the measurement module 212 monitors the performance of each of the workloads at regular intervals, such as the first time interval described above, and stores the performance related information in the monitored data 220. The first controller 112 further identifies workloads that have over-achieved, under achieved, and optimally achieved respective expected QoS, in the absence of the dynamic resource control. Based on the monitored data 220, reference performance values for each application command are computed over an extended duration and stored in the performance data 222.

At block 310, based on the performances of all the workloads, it is determined whether all the workloads achieved their expected QoSs. The determination is done, in an implementation, by the second controller 114. If it is determined that all the workloads achieved their expected QoS (‘Yes’ path from block 310), the performance statistics of ail the workloads are computed again over the predetermined time interval (block 305).

If it is determined that some or all of the workloads did not achieve their expected QoS (‘No’ path from block 310), it is further determined, at block 315, whether a threshold proportion of all the workloads did not achieve the corresponding expected QoS. In one implementation, the determination of whether a threshold proportion of all the workloads did not achieve their expected QoS is based on the performance statistics stored in the performance data 222.

If it is determined that the threshold proportion of the workloads did not achieve their expected QoS, block 315 branches to block 320 (‘Yes’ path from block 315). In an implementation, the second controller 114 performs this determination. Further, at block 320, dynamic resource allocation control is deactivated, because such dynamic resource allocation control was not able to achieve the expected QoS. In an implementation, both the first controller 112 and the second controller 114 are disabled and the scheduling module 116 schedules the workloads based on a predefined logic.

At block 325, it is determined that whether a predetermined period of time has elapsed without the dynamic resource allocation control for the workloads. Upon affirmative determination (‘Yes’ path from block 325), the performance statistics of all the workloads are computed again over the predetermined time interval (block 305), otherwise the dynamic resource allocation control of the scheduler is kept disabled (block 320).

Returning to block 315, if it is determined that some of the workloads, the proportion of such workloads being less than the threshold proportion, did not achieve their expected QoS, block 315 proceeds to block 330. At block 330, it is determined whether at least one workload has an anomaly in corresponding resource allocation. In one implementation, the second controller 114 performs this determination. If no workload has an anomaly in the corresponding resource allocation, block 330 branches to (“No” path), block 305. On the other hand, if one or more workloads with anomalies in the corresponding resource allocations are identified, block 330 branches to block 335 (“Yes” path).

At block 335, optimal resources are determined for the workloads that had anomalies in the corresponding resource allocations. In an implementation, the second controller 114, in conjunction with the performance monitoring module 214, determines the optimal resources. The determination of optimal resource has been described in detail with reference to FIG. 2 above.

At block 340, optimal resources determined at the block 330 are associated with the respective workloads. In an implementation, the association of the optimal resources with the respective workloads is done by the second controller 114. The scheduling module 116 allocates the associated optimal resources to the respective workloads. In another implementation, the second controller 114 directs the first controller 112 to control the scheduling module 116, based on the optimal resources associated with the respective workloads.

At block 345, it is determined whether performances of all such workloads, which were allocated the respective optimal resources, degraded over another predetermined time interval, which may be the same as, or different form, the predetermined time interval at block 305. In an implementation, the second controller 114 performs this determination. Upon affirmative determination, block 340 branches to block 345. On the other hand, if the performance of only some of such workloads degraded ever the other predetermined time interval, block 340 proceeds to block 350.

At block 350, the allocation of optimal resources to all such workloads, which were allocated the respective optimal resources, is discontinued and the performance statistics of all the workloads are computed again over she predetermined time interval (block 305). In one implementation, the second controller 114 discontinues the association of the optimal resources with the respective workloads and allows the first controller 112 to compute the resources to be allocated to the workloads.

At block 355, allocation of optimal resources is discontinued only for those workloads whose performances degraded over the other predetermined time interval. Further the performance statistics of all the workloads are computed again over the predetermined time interval (block 305).

Although implementations of workload performance control in computing devices have been described in language specie to structural features and/or methods, it is to be understood that the invention is not necessarily limited to the specific features or methods described. Rather, the specific features and methods are disclosed as exemplary implementations for the workload performance control.

I/We claim:

1. A method to provide workload performance control, the method comprising:
obtaining, for a second time interval comprising a plurality of first time intervals, performance statistics associated with a plurality of workloads, the performance statistics based on data (220) monitored at each of the plurality of first time intervals;
identifying at least one workload from the plurality of workloads using the performance statistics, the at least one workload having an anomaly in resource allocation; and
associating resources with the at least one workload to at least mitigate the anomaly.

2. The method as claimed in claim 1, wherein the method further comprises determining the resources for the at least one workload to at least mitigate the anomaly.

3. The method as claimed in claim 1, wherein the method further comprises:
monitoring performance of the at least one workload for another time interval; and
discontinuing the resources to be associated with the at least one workload, based at least on the monitoring.

4. The method as claimed in claim 1, wherein the identifying comprises:
detecting a peak performance of each of the plurality of workloads based on the obtaining;
ascertaining a minimum resource allocation corresponding to the peak performance of each of the plurality of workloads; and
comparing the minimum resource allocation with a current resource allocation of each of the plurality of workloads.

5. The method as claimed in claim 4, wherein the associating comprises selecting the minimum resource allocation as the resources for the at least one workload, based on the comparing.

6. The method as claimed in claim 1, wherein the identifying comprises detecting, based on the obtaining, at least one of resource hogging by the at least one workload and oscillations in the performances of the at least one workload.

7. A computing device (102) comprising:
a processor (202); and
a memory (206) coupled to the processor (202), wherein the memory (208) comprises:
a Quality of Service (QoS) control module (110) configured to,
control performance of each of a plurality of workloads, based at least on data (220) monitored at a first time interval; and
control the performance of the plurality of workloads based at least on the data (220) monitored over a second time interval, wherein the second time interval comprises a plurality of first time intervals.

8. The computing device (102) as claimed in claim 7, wherein the computing device (102) further comprises a performance monitoring module (214) configured to determine performance statistics of the plurality of workloads over the second time interval.

9. The computing device (102) as claimed in claim 7, wherein the computing device (102) is a host device (102) implemented within a storage area network (100).

10. The computing device (102) as claimed in claim 7, wherein the QoS control module (110) is further configured to identify, from the plurality of workloads, at least one workload having an anomaly in resource allocation, the at least one workload is identified based on performance statistics, of the at least one workload determined over the second time interval.

11. The computing device (102) as claimed in claim 10, wherein the QoS control module (110) is configured to direct a scheduling module (116) to allocate resources to the at least one workload for at least reducing the anomaly.

12. The computing device (102) as claimed in claim 7, wherein the QoS control module (110) is further configured to:
determine whether a threshold proportion of the plurality of workloads have corresponding actual QoS less than corresponding expected QoS, based on performance statistics of the plurality of the workloads determined over the second time interval; and
discontinue controlling, for a predetermined time period, the performance of the plurality of workloads when the threshold proportion of the plurality of workloads have the corresponding achieved QoS less than the corresponding expected QoS.

13. A computer-readable medium having computer-executable instructions that when executed perform acts comprising:
obtaining, for a plurality of workloads, data (220) monitored at each of a plurality of first time intervals;
computing, based on the monitored data (220) obtained at each of the plurality of the first intervals, performance statistics of each of the plurality of workloads for a second time interval, the second time interval comprising the plurality of first time intervals;
ascertaining an anomaly in resource allocation associated with at least one workload, from the plurality of workloads, based on the performance statistics; and
associating resources with the at least one workload to at least mitigate the anomaly.

14. The computer-readable medium as claimed in claim 13, wherein the anomaly in the resource allocation includes at least one of allocating resources to attain an unachievable expected QoS associated with the at least one workload, oscillations in resource allocation associated with the at least one workload, and allocating resources that results in resource hogging by the at least one workload.

15. The computer-readable medium as claimed in claim 13, wherein the computer-readable medium further comprises instructions to receive information pertaining to an expected QoS associated with each of the plurality of workloads.
